(19) United States
(12) Patent Application Publication
(10) Pub. No.: US 2026/0307454 A1
(43) Pub. Date: Oct. 8, 2026

(54) APPARATUS AND METHOD FOR PREDICTING AN AIR CONDITIONING USAGE SCENARIO USING AN ARTIFICIAL INTELLIGENCE-BASED MODEL

(71) Applicants: HYUNDAI MOTOR COMPANY, Seoul (KR); KIA CORPORATION, Seoul (KR)

(72) Inventor: Kang Il Park, Hwaseong-si (KR)

(73) Assignees: HYUNDAI MOTOR COMPANY, Seoul (KR); KIA CORPORATION, Seoul (KR)

(21) Appl. No.: 19/289,788

(22) Filed: Aug. 4, 2025

(30) Foreign Application Priority Data
Apr. 2, 2025 (KR) 10-2025-0042962

(51) Int. Cl. B60H 1/00; G05B 13/02

(52) U.S. Cl. CPC B60H 1/0073; G05B 13/0265

(57) ABSTRACT

An apparatus for predicting an air conditioning usage scenario obtains a plurality of pieces of first air conditioning signal data from a plurality of electronic control units (ECUs) that are provided in a vehicle to perform control of respective functions in the vehicle. The apparatus inputs the plurality of pieces of first air conditioning signal data to an artificial intelligence-based prediction model to obtain a usage scenario for each option of air conditioning. The apparatus transmits the usage scenario to the vehicle.

### CROSS-REFERENCE TO RELATED APPLICATION

This application claims the benefit of and priority to Korean Patent Application No. 10-2025-0042962, filed in the Korean Intellectual Property Office on Apr. 2, 2025, the entire contents of which are hereby incorporated herein by reference.

### TECHNICAL FIELD

The present disclosure relates to a technology for predicting a customer usage scenario using data analysis and an artificial intelligence-based model. More particularly, the present disclosure relates to technologies for analyzing sensor data of a vehicle associated with an air conditioning signal and accurately predicting an air conditioning signal usage scenario of a customer using the artificial intelligence-based model.

### BACKGROUND

It is difficult for conventional rule-based logic to actually and efficiently reflect air conditioning system preference scenarios of various customers. Thus, customer satisfaction and an actual usage rate of an air conditioning automation system loaded into an existing vehicle are considerably lowered.

Unlike a static system, a vehicle that is moving in the outside is subject to many external influences. Air conditioning usage data of a customer and sensor data of a vehicle, that are actually collected, are observed in a very irregular pattern.

### SUMMARY

The present disclosure has been made to solve the above-mentioned problems occurring in the prior art while advantages achieved by the prior art are maintained intact.

An aspect of the present disclosure provides an artificial intelligence-based prediction technology for extracting related data of a vehicle, that has an influence on a usage scenario of a customer per air conditioning option, and effectively reflecting (or determining) customer preference based on the extracted data.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an apparatus for predicting an air conditioning usage scenario is provided. The apparatus includes a processor, a memory, and a communication device. The processor is configured to obtain a plurality of pieces of first air conditioning signal data from a plurality of electronic control units (ECUs) provided in a vehicle to perform control of respective functions in the vehicle. The processor is also configured to input the plurality of pieces of first air conditioning signal data to an artificial intelligence-based prediction model to obtain a usage scenario for each option of air conditioning. The processor is additionally configured to transmit the usage scenario to the vehicle.

In an implement, the processor may be configured to obtain a plurality of pieces of training air conditioning signal data and a plurality of pieces of training sensor data for training from the plurality of ECUs in advance, prior to obtaining the plurality of pieces of first air conditioning signal data. The processor may be configured to pre-train the artificial intelligence-based prediction model based on the plurality of pieces of training air conditioning signal data and the plurality of pieces of training sensor data.

In an implement, the processor may be configured to standardize and normalize a variate included in the plurality of pieces of training air conditioning signal data and the plurality of pieces of training sensor data.

In an implement, the processor may be configured to analyze a correlation between the plurality of pieces of training air conditioning signal data and the plurality of pieces of training sensor data to classify the plurality of pieces of training sensor data corresponding to each of the plurality of pieces of training air conditioning signal data.

In an implement, the processor may be configured to select a predetermined number of pieces of 1-1st training sensor data among a plurality of pieces of first training sensor data corresponding to first training air conditioning signal data, based on the correlation. The processor may also be configured to generate the training air conditioning signal data and the pieces of 1-1st training sensor data as a training dataset for a first air conditioning option.

In an implement, the processor may be configured to pre-train the prediction model for the first air conditioning option, based on the training dataset for the first air conditioning option.

In an implement, the artificial intelligence-based prediction model may be configured to output a probability distribution to belong to each category for input air conditioning signal data.

In an implement, the artificial intelligence-based prediction model may be trained based on a cross entropy loss function to output a probability distribution to belong to each category for input air conditioning signal data.

In an implement, the vehicle may adjust a setting for each option of air conditioning of the vehicle based on the usage scenario.

In an implement, the processor may be configured to obtain a plurality of pieces of second air conditioning signal data and a plurality of pieces of sensor data from the plurality of ECUs, after transmitting the usage scenario to the vehicle. The processor may also be configured to additionally train the prediction model based on the plurality of pieces of second air conditioning signal data and the plurality of pieces of sensor data.

According to another aspect of the present disclosure, a method for predicting an air conditioning usage scenario is provided. The method includes obtaining a plurality of pieces of first air conditioning signal data from a plurality of electronic control units (ECUs) provided in a vehicle to perform control of respective functions in the vehicle. The method also includes inputting the plurality of pieces of first air conditioning signal data to an artificial intelligence-based prediction model to obtain a usage scenario for each option of air conditioning. The method additionally includes transmitting the usage scenario to the vehicle.

In an implement, the method may further include obtaining a plurality of pieces of training air conditioning signal data and a plurality of pieces of training sensor data for training from the plurality of ECUs in advance, prior to obtaining the plurality of pieces of first air conditioning signal data, and pre-training the artificial intelligence-based prediction model based on the plurality of pieces of training air conditioning signal data and the plurality of pieces of training sensor data.

In an implement, the method may further include standardizing and normalizing a variate included in the plurality of pieces of training air conditioning signal data and the plurality of pieces of training sensor data.

In an implement, the method may further include analyzing a correlation between the plurality of pieces of training air conditioning signal data and the plurality of pieces of training sensor data to classify the plurality of pieces of training sensor data corresponding to each of the plurality of pieces of training air conditioning signal data.

In an implement, the method may further include selecting a predetermined number of pieces of 1-1st training sensor data among a plurality of pieces of first training sensor data corresponding to first training air conditioning signal data, based on the correlation, and generating the training air conditioning signal data and the pieces of 1-1st training sensor data as a training dataset for a first air conditioning option.

In an implement, pre-training the artificial intelligence-based prediction model may include pre-training the prediction model for the first air conditioning option, based on the training dataset for the first air conditioning option.

In an implement, the method may further include adjusting, by the vehicle, a setting for each option of air conditioning of the vehicle based on the usage scenario.

In an implement, the method may further include obtaining a plurality of pieces of second air conditioning signal data and a plurality of pieces of sensor data from the plurality of ECUs, after transmitting the usage scenario to the vehicle, and additionally training the prediction model based on the plurality of pieces of second air conditioning signal data and the plurality of pieces of sensor data.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of a system for predicting an air conditioning usage scenario according to an implement of the present disclosure;

FIGS. 2, 3, and 4 are flowcharts illustrating a method for predicting an air conditioning usage scenario according to an implement of the present disclosure;

FIG. 5 is a drawing illustrating the entire process of air conditioning usage scenario prediction according to an implement of the present disclosure;

FIG. 6 is a drawing illustrating a data cleaning process based on a correlation according to an implement of the present disclosure;

FIG. 7 is a drawing illustrating a training process of the prediction model according to an implement of the present disclosure; and

FIG. 8 illustrates a computing system according to an implement of the present disclosure.

### DETAILED DESCRIPTION

Hereinafter, some implements of the present disclosure are described in detail with reference to the accompanying drawings. In adding the reference numerals to the components of each drawing, it should be noted that the identical components are designated by the identical numerals even when the components are displayed on different drawings. Further, in describing the implement of the present disclosure, where it was determined that a detailed description of well-known features or functions would obscure the gist of the present disclosure, the detailed description thereof has been omitted.

In describing the components of the implement according to the present disclosure, terms such as first, second, “A”, “B”, (a), (b), and the like may be used. These terms are merely intended to distinguish one component from another component. The terms do not limit the nature, sequence, or order of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present application.

In the present disclosure, when a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

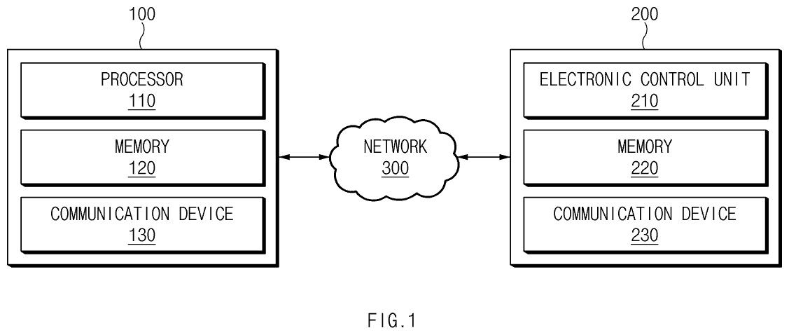

Hereinafter, implements of the present disclosure are described in detail with reference to FIGS. 1-8.

FIG. 1 is a block diagram illustrating a configuration of a system for predicting an air conditioning usage scenario according to an implement of the present disclosure.

Referring to FIG. 1, the system for predicting the air conditioning usage scenario may include an air conditioning usage scenario prediction apparatus 100, a vehicle 200, and/or a network 300.

In an implement, the air conditioning usage scenario prediction apparatus 100 may be a computable computing device.

In an implement, the air conditioning usage scenario prediction apparatus 100 may be loaded into a smartphone, a robot, a vehicle, a mobility device, and/or the like. For example, the air conditioning usage scenario prediction apparatus 100 may be implemented in the vehicle 200. In this case, the vehicle control apparatus 100 may be integrally configured with control units in the vehicle 200 or may be implemented as a separate device to be connected with the control units of the vehicle 200 by a separate connection means.

In another implement, the air conditioning usage scenario prediction apparatus 100 may be present independently of the smartphone, the robot, the vehicle, the mobility device, and/or the like. The air conditioning usage scenario prediction apparatus 100 may transmit and receive data, a signal, information, or the like over the network 300.

The air conditioning usage scenario prediction apparatus 100 may include a processor 110, a memory 120, and a communication device 130. According to various implements, the configuration of the air conditioning usage scenario prediction apparatus 100 is not limited to that shown in FIG. 1 and some components may be further added or omitted. In an implement, the air conditioning usage scenario prediction apparatus 100 may further include an output device (not shown). For example, the output device of the air conditioning usage scenario prediction apparatus 100 may include, or may be communicatively coupled to, a display included in the vehicle 200. The display may visually display information (e.g., air conditioning state information or the like) associated with the vehicle 200.

In an implement, the processor 110 may be include or be composed of one or more cores and may include a processor for performing an operation associated with data processing, for example, a central processing unit (CPU), a general purpose graphics processing unit (GPGPU), or a tensor processing unit (TPU) of the air conditioning usage scenario prediction apparatus 100.

The processor 110 may perform computation for training of an artificial intelligence-based model. For example, the processor 110 may perform calculation for training of the artificial intelligence-based model, such as processing of input data for training in deep learning, feature extraction from the input data, error calculation, and/or a weight update of the artificial intelligence-based model using backpropagation. The processor 110 may process learning of a network function. Furthermore, in an implement, the processor 110 may use processors of a plurality of computing devices together to perform learning of the network function and data processing of the network function.

The processor 110 may generally control the overall operation of the air conditioning usage scenario prediction apparatus 100. The processor 110 may process a signal, data, information, or the like input or output via the components included in the air conditioning usage scenario prediction apparatus 100 and/or may run an application program stored in the memory 120, thus providing or processing appropriate information or an appropriate function to a user.

In an implement, the processor 110 may analyze and clean various pieces of signal data, state change data, sensor data, or the like received from the vehicle 200 via vehicle customer relation management (VCRM).

In an implement, the memory 120 may store any type of information generated or determined by the processor 110 and/or any type of information received by the communication device 130. For example, the memory 120 may store an artificial intelligence-based prediction model. The memory 120 may operate by the processor 110.

The memory 120 may include at least one type of storage medium among a flash memory type memory, a hard disk type memory, a multimedia card micro type memory, a card type memory (e.g., an SD or XD memory), a random access memory (RAM), a static RAM (SRAM), a read-only memory (ROM), an electrically erasable programmable ROM (EEPROM), a programmable ROM (PROM), a magnetic memory, a magnetic disc, and/or an optical disc. The air conditioning usage scenario prediction apparatus 100 may operate in conjunction with web storage for performing a storage function of the memory 120 on the Internet. The above-mentioned description of the memory 120 is only an example and the present disclosure is not limited thereto.

The communication device 130 may include any wired and wireless communication network capable of transmitting and receiving any type of data, information, signal, and the like. The communication device 130 may communicate with an external device. The external device may include, for example, the vehicle 200.

The vehicle 200 may include an electronic control unit 210, a memory 220, a communication device 230, and the like. According to various implements, the configuration of the vehicle 200 is not limited to that shown in FIG. 1 and some components may be further added or omitted.

The electronic control unit 210 may receive signal data or sensor data associated with a corresponding function from various manipulation switches and sensors. The electronic control unit 210 may include an engine control unit, a shift control unit, a body control unit, an anti-lock braking system (ABS), a constant-speed control unit, an air conditioning control unit, or the like. The electronic control unit 210 may be configured in plural (e.g., the control unit 210 may include, or be otherwise configured with, multiple control units).

In an implement, the air conditioning control unit may control a device associated with air conditioning. For example, the device associated with the air conditioning may include one or more of an intake door for adjusting an amount in which external air introduced from the outside of the vehicle and internal circulation air circulated in the vehicle are introduced into the vehicle, a blow motor for moving external air introduced from the outside of the vehicle into the vehicle or moving internal circulation air into the vehicle again, a rear fan for discharging air in the vehicle to the outside of the vehicle, and/or the like.

In an implement, the electronic control unit 210 may transmit pieces of air conditioning signal data to the air conditioning usage scenario prediction apparatus 100 via the communication device 230, while controlling the device associated with the air conditioning.

The memory 220 may store any type of information generated or determined by the electronic control unit 210 and/or any type of information received by the communication device 230. For example, the memory 220 may store air conditioning signal data, sensor data, or the like.

The communication device 230 may include any wired and wireless communication network capable of transmitting and receiving any type of data, information, signal, and the like. The communication device 230 may communicate with an external device. The external device may include, for example, the air conditioning usage scenario prediction apparatus 100.

The network 300 may include any wired and wireless communication network capable of transmitting and receiving any type of data, signal, and the like. In detail, the network 300 may include a wired and wireless communication network (e.g., an Ethernet or the like) capable of transmitting and receiving data, a signal, and the like between the air conditioning usage scenario prediction apparatus 100 and the vehicle 200.

The air conditioning usage scenario prediction apparatus 100 and the vehicle 200 may operate by being divided independently of each other or may operate as the air conditioning usage scenario prediction apparatus 100 is included in the vehicle 200.

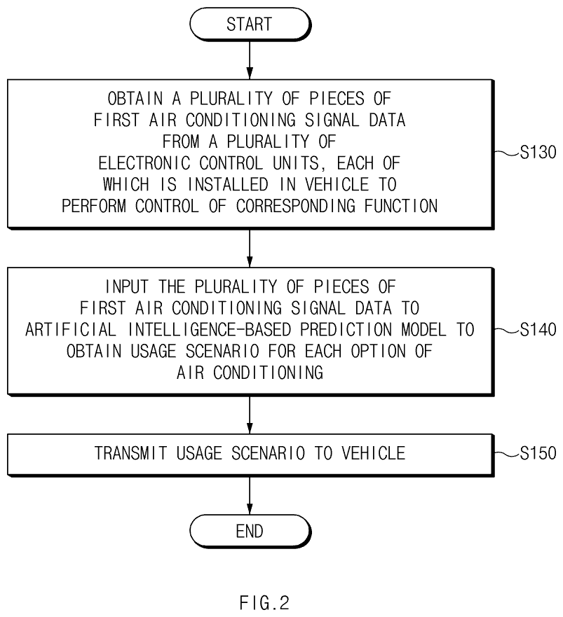

Hereinafter, a method for predicting an air conditioning usage scenario, according to an implement of the present disclosure, is described in more detail with reference to FIGS. 2-4. FIGS. 2-4 are flowcharts illustrating the method for predicting the air conditioning usage scenario performed in an apparatus for predicting the air conditioning usage scenario according to an implement of the present disclosure.

Referring to FIG. 2, in an operation S130, a processor (e.g., the processor 110) of an air conditioning usage scenario prediction apparatus (e.g., the air conditioning usage scenario prediction apparatus 100) may obtain a plurality of pieces of first air conditioning signal data from a plurality of electronic control units, each of which is provided (e.g., installed) in a vehicle 200 to perform control of a corresponding function.

In an operation S140, the processor 110 may input the plurality of pieces of first air conditioning signal data to an artificial intelligence-based prediction model to obtain a usage scenario for each option of air conditioning.

In an operation S150, the processor 110 may transmit the usage scenario to the vehicle 200.

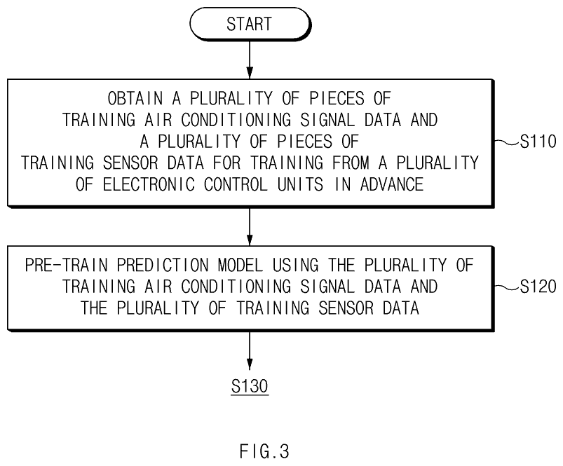

Referring to FIG. 3, in an operation S110, the processor 110 may obtain a plurality of pieces of training air conditioning signal data and a plurality of pieces of training sensor data for training from the plurality of electronic control units in advance, before obtaining the plurality of pieces of first air conditioning signal data in the operation S130.

The processor 110 may perform a preprocessing task for the plurality of pieces of training air conditioning signal data and the plurality of pieces of training sensor data.

For example, after obtaining the plurality of training air conditioning signal data and the plurality of pieces of training sensor data in the operation S110, the processor 110 may standardize and/or normalize a variate included in the plurality of pieces of training air conditioning signal data and the plurality of pieces of training sensor data.

In an implement, the processor 110 may convert the variate included in the plurality of pieces of training air conditioning signal data and the plurality of pieces of training sensor data into a standard normal distribution.

In an implement, the processor 110 may convert the variate included in the plurality of pieces of training air conditioning signal data and the plurality of pieces of training sensor data into a certain interval (e.g., between 0 and 1).

In an implement, the processor 110 may downsample the plurality of pieces of training air conditioning signal data and the plurality of pieces of training sensor data, the variate of which is standardized and/or normalized. For example, the processor 110 may select a sample at a certain interval or may select a representative value (e.g., a maximum value, an average value, or the like) in a specific area among the plurality of pieces of training air conditioning signal data and the plurality of pieces of training sensor data, the variate of which is standardized and/or normalized.

The pieces of data collected or obtained from the plurality of electronic control units may include multivariate time-series data composed of manipulable air conditioning signal data of the vehicle 200 and various pieces of sensor data of the vehicle 200, that are recorded per unit time, while a large number of users (e.g., customers) are driving the vehicle 200. For example, the air conditioning signal data and the various pieces of sensor data of the vehicle 200 may include an input signal of a button of the vehicle 200, an input signal of a sensor of the vehicle 200, various pieces of information of the vehicle 200, or the like.

Because data with high association differs in data collected for each air conditioning signal to be predicted, the processor 110 may extract and individually and additionally classify data with high association for each air conditioning signal via correlation analysis.

In an implement, after obtaining the plurality of pieces of training air conditioning signal data and the plurality of pieces of training sensor data in the operation S110, the processor 110 may analyze a correlation between the plurality of pieces of training air conditioning signal data and the plurality of pieces of training sensor data, thus classifying the plurality of pieces of training sensor data corresponding to each of the plurality of pieces of training air conditioning signal data.

The processor 110 may additionally select a variate with high association to improve learning efficiency among the plurality of pieces of training sensor data classified for each of the plurality of pieces of training air conditioning signal data.

In an implement, the processor 110 may select a predetermined number (e.g., 10 or the like) of first 1-1st training sensor data, among a plurality of first training sensor data corresponding to first training air conditioning signal data, based on the correlation. The processor 110 may generate the first training air conditioning signal data and the pieces of 1-1st training sensor data as a training dataset for a first air conditioning option. The processor 110 may generate a training dataset including training air conditioning signal data and training sensor data for each air conditioning option in the above-mentioned method.

In an operation S120, the processor 110 may pre-train the prediction model using (or based on) the plurality of training air conditioning signal data and the plurality of training sensor data.

In an implement, the processor 110 may pre-train the prediction model using (or based on) the training dataset for each air conditioning option. For example, the processor 110 may pre-train the prediction model for the first air conditioning option, using (or based on) the training dataset for the first air conditioning option.

In an implement, the prediction model may be trained by regarding the plurality of pieces of training air conditioning signal data and the plurality of pieces of training sensor data as categorical data. Thus, the prediction model may output a probability distribution to belong to each category for the input air conditioning signal data.

In an implement, the prediction model may be trained using (or based on) a cross entropy loss function to output the probability distribution to belong to each category for the input air conditioning signal data.

In an implement, the prediction model may be plural in number. Each of the plurality of prediction models may correspond to each air conditioning signal. For example, the first prediction model may be trained using (or based on) a training dataset corresponding to a first air conditioning signal and the second prediction model may be trained using (or based on) a training dataset corresponding to a second air conditioning signal. Thus, a prediction model input for each air conditioning signal may differ. However, the structure of the prediction model is not limited thereto. A plurality of air conditioning signals may be input to one prediction model to output each predicted air conditioning signal.

In an implement, the vehicle 200 may adjust (e.g., a processor or a controller of the vehicle 200 may adjust) a setting for each option of air conditioning of the vehicle 200 based on the received usage scenario.

In an implement, the processor 110 may additionally train the prediction model using (or based on) pieces of air conditioning signal data additionally obtained, after the vehicle 200 adjusts the setting of the air conditioning option depending on the usage scenario.

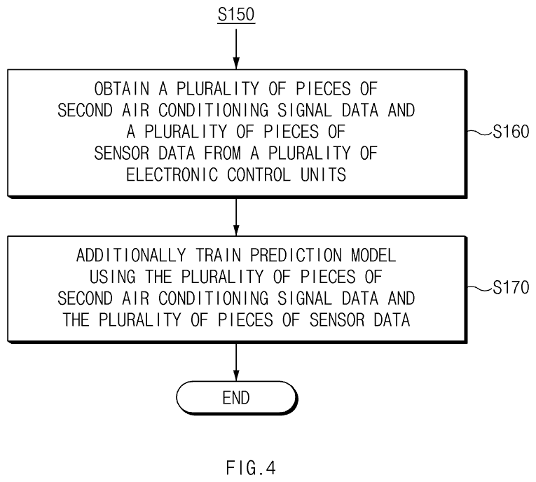

For example, referring to FIG. 4, in an operation S160, the processor 110 may obtain a plurality of pieces of second air conditioning signal data and a plurality of pieces of sensor data from the plurality of electronic control units, after transmitting the usage scenario to the vehicle 200.

In an operation S170, the processor 110 may additionally train the prediction model using (or based on) the plurality of second pieces of air conditioning signal data and the plurality of pieces of sensor data.

For example, the processor 110 may standardize and normalize the plurality of pieces of second air conditioning signal data and the plurality of pieces of sensor data. The processor 110 may analyze a correlation between the plurality of pieces of second air conditioning signal data and the plurality of pieces of sensor data, thus classifying the plurality of pieces of sensor data corresponding to each of the plurality of pieces of second air conditioning signal data. The processor 110 may generate a training dataset including the second air conditioning signal data and the sensor data for each air conditioning option. The processor 110 may additionally train the prediction model using (or based on) the training dataset including the second air conditioning signal data and the sensor data for each air conditioning option.

A detailed method for additionally training the prediction model using (or based on) the plurality of pieces of second air conditioning signal data and the plurality of pieces of sensor data may correspond or be similar to the above-described method for pre-training the prediction model.

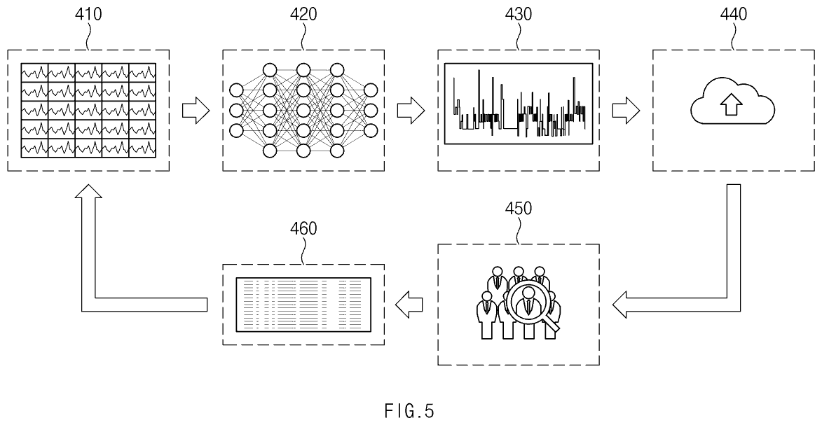

FIG. 5 is a drawing illustrating a process of air conditioning usage scenario prediction according to an implement of the present disclosure. A detailed method of respective components described in FIG. 5 may be replaced with contents described above with reference to FIGS. 1-4.

Referring to FIG. 5, a processor (e.g., the processor 110) may obtain a plurality of pieces of first air conditioning signal data 410 from a plurality of electronic control units, each of which is provided (e.g., installed) in a vehicle to perform control of a corresponding function.

The processor 110 may input the plurality of pieces of first air conditioning signal data 410 to a pre-trained prediction model 420 to obtain a usage scenario 430 for each option of air conditioning.

The processor 110 may provide a vehicle 450 of a user with the usage scenario 430 via over-the-air (OTA) 440.

The processor 110 may collect and/or obtain a plurality of pieces of second air conditioning signal data and/or a plurality of pieces of sensor data 460 from the plurality of electronic control units included in the vehicle 450 of the user, via a communication device 130.

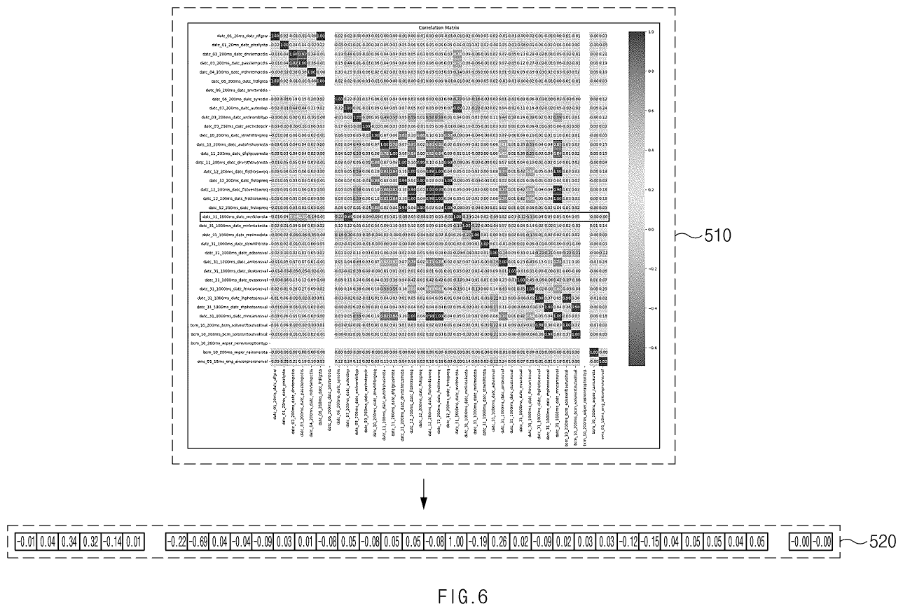

FIG. 6 is a drawing illustrating a data cleaning process based on a correlation according to an implement of the present disclosure.

There may be a need to select a variate with high association in a plurality of pieces of training sensor data or a plurality of pieces of sensor data to improve efficiency and consistency of training for a prediction model. Applying the variate to all training causes the problem of a computation time. Variates with low association have a negative influence on training.

To address such a problem, a processor (e.g., the processor 110) may use a predetermined number of (e.g., 10) variates in the plurality of training sensor data and the plurality of pieces of sensor data. The processor 110 may use a correlation matrix 510 to select the predetermined number of variates.

The processor 110 may select data with a predetermined threshold (e.g., 0.2 or another suitable threshold) or more among a plurality of pieces of training sensor data or a plurality of pieces of sensor data 520 for each of pieces of air conditioning signal data in the correlation matrix 510. When the prediction model is plural in number, each prediction model may select a different input signal to improve performance prediction consistency for each signal.

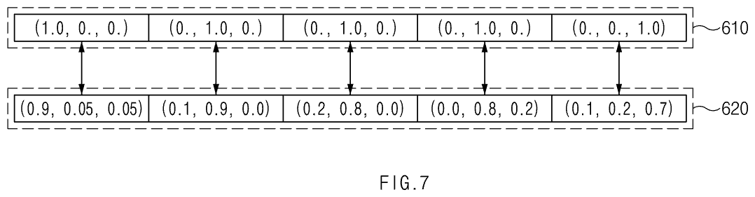

FIG. 7 is a drawing illustrating a training process of the prediction model according to an implement of the present disclosure.

Referring to FIG. 7, the prediction model may include an output layer for outputting a probability distribution to belong to each category, rather than predicting a real value of an air conditioning signal.

The prediction model may be trained by regarding time-series data collected or obtained from a plurality of electronic control units as categorical data.

The prediction model may be trained using (or based on) a calculated cross entropy loss. In an implement, the cross entropy loss may be obtained by measuring a difference between a predicted probability distribution and a real probability distribution.

In an implement, the prediction model may be trained in the direction of comparing a real air conditioning signal probability distribution 610 with a predicted air conditioning signal probability distribution 620 and minimizing a difference between the air conditioning signal probability distribution 610 and the predicted air conditioning signal probability distribution 620.

An artificial intelligence-based model (e.g., the prediction model) in the specification may be composed of a set of calculation units connected with each other, which are capable of being generally referred to as nodes. Such nodes may be referred to as neurons. The artificial intelligence-based model may be configured to include at least one node. Nodes (or neurons) constituting the artificial intelligence-based models may be connected with each other by one or more links.

In the artificial intelligence-based model, one or more nodes connected via the link may relatively form a relationship between an input node and an output node. The concept of the input node and the output node may be relative. Any node with an output node relationship for one node may have an input node relationship in a relationship with another node and the reverse may be established. As described above, the relationship between the input node and the output node may be generated around the link. One or more output nodes may be connected with one input node via the link and the reverse may be established.

In the relationship between the input node and the output node, that are connected with each other via one link, a value of data of the output node may be determined based on data input to the input node. Herein the link that interconnects the input node and the output node may have a weight. The weight may vary and may vary by a user or an algorithm to perform a function desired by the artificial intelligence-based model. For example, when one or more input nodes are interconnected with one output node by respective links, the output node may determine an output node value based on values input to input nodes connected with the output node and the weight set to the link corresponding to the respective input nodes.

As described above, the artificial intelligence-based model may form the relationship between the input node and the output node in the artificial intelligence-based model as one or more nodes are connected with each other via one or more links. A characteristic of the artificial intelligence-based model may be determined according to the number of nodes and links in the artificial intelligence-based model, a correlation between the nodes and the links, or a weight assigned to each of the links. For example, when there are the same number of nodes and links and there are two artificial intelligence-based models in which weights of the links are different from each other, the two artificial intelligence-based models may be recognized as being different from each other.

The artificial intelligence-based model may be composed of a set of one or more nodes. A subset of the nodes constituting the artificial intelligence-based model may constitute a layer.

An initial input node may refer to one or more nodes to which data is directly input without passing through a link in a relationship with other nodes among nodes of the artificial intelligence-based model. Alternatively, the initial input node may refer to nodes which do not have other input nodes connected with the link, in a relationship with one node relative to the link, in the artificial intelligence-based model network. Similarly, a final output node may refer to one or more nodes which do not have the output node, in a relationship with other nodes among the nodes in the artificial intelligence-based model. Furthermore, a hidden node may refer to nodes constituting the artificial intelligence-based model, rather than the initial input node and the final output node.

The artificial intelligence-based model according to an implement may have a form in which the number of nodes of the input layer is the same as the number of nodes of the output layer and the number of nodes decreases and increases again as it progresses from the input layer and the hidden layer.

The artificial intelligence-based model according to an implement may have a form in which the number of the nodes of the input layer is less than the number of the nodes of the output layer and the number of the nodes decreases as it progresses from the input layer to the hidden layer.

The artificial intelligence-based model according to an implement may have a form in which the number of the nodes of the input layer is greater than the number of the nodes of the output layer and the number of the nodes increases as it progresses from the input layer to the hidden layer.

The artificial intelligence-based model according to an implement may have a form in which the above-mentioned artificial intelligence-based models are combined with each other.

In an implement, the artificial intelligence-based model may include a deep neural network (DNN) (or a deep artificial intelligence-based model). The DNN may refer to an artificial intelligence-based model including a plurality of hidden layers other than the input layer and the output layer. Latent structures of data may be identified using (or based on) the DNN. In other words, latent structures of an image (e.g., which object is in the image or the like) may be identified. The DNN may include a convolutional neural network (CNN), a recurrent neural network (RNN), a transformer, or the like. The description of the DNN described above is only an example and the present disclosure is not limited thereto.

In an implement, the transformer may include or be composed of an encoder for encoding pieces of embedded data and a decoder for decoding the encoded pieces of data. The transformer may have a structure for receiving a series of data and outputting a different type of series of data via an encoding and decoding step. In an implement, the series of data may be processed in a form computable by the transformer. The process of processing the series of data in the form computable by the transformer may include an embedding process. Expressions, such as a data token, an embedding vector, and an embedding token, may refer to pieces of data embedded in a form capable of being processed by the transformer.

The transformer may process an encoder and decoders in the transformer using an attention algorithm to encode and decode a series of data. The attention algorithm may refer to an algorithm for obtaining a similarity to one or more keys for a given query, reflecting the obtained similarity in a value corresponding to each key, and performing weighted sum of values in which the similarity is reflected to calculate an attention value.

Various types of attention algorithms may be classified according to how the query, the key, and the value are set. For example, when the query, the key, and the value are set to be the same as one another to obtain attention, this may refer to a self-attention algorithm. When the embedding vector is reduced in dimension to process a series of data which are input in parallel and an individual attention head is obtained for each segmented embedding vector to obtain attention, this may refer to a multi-head attention algorithm.

In an implement, the transformer may be composed of modules for performing a plurality of multi-head self-attention algorithms or a multi-head encoder-decoder algorithm. In an implement, the transformer may also include additional components, rather than the attention algorithm, such as an embedding layer, a normalization layer, and softmax.

The artificial intelligence-based model may be represented by any structure of network structure described above, which includes the input layer, the hidden layer, and the output layer.

A neural network available in the artificial intelligence-based model may be trained in at least one of supervised learning, unsupervised learning, semi-supervised learning, transfer learning, active learning, or reinforcement learning. The training of the neural network may be a process of applying knowledge for the neural network to perform a specific operation to the neural network.

The neural network may be trained in the direction of minimizing an error in output. The training of the neural network may be a process of repeatedly inputting training data to the neural network in the training of the neural network, calculating an error in output and target of the neural network for the training data, and backpropagating the error in neural network in the direction of the input layer of the neural network from the output layer of the neural network in the direction of reducing the error to update a weight of each node of the neural network.

Training data (e.g., labeled training data) in which each of pieces of training data is labeled with the ground truth may be used for the supervised learning. Each of pieces of training data may fail to be labeled with the ground truth for the unsupervised learning.

For example, training data for supervised learning about data classification may be data in which each of pieces of training data is labeled with a category. The labeled training data may be input to the neural network and the output (or category) of the neural network and the label of the training data may be compared with each other, such that an error may be calculated.

As another example, for unsupervised learning about data classification, training data, which is an input, may be compared with the output of the neural network, such that an error may be calculated. The calculated error may be backpropagated in a reverse direction (i.e., the direction of the input layer from the output layer) in the neural network and connection weights of respective nodes of each layer of the neural network may be updated according to the backpropagation. A variance in connection weight of each node, which is updated, may be determined according to a learning rate. The calculation of the neural network for the input data and the backpropagation of the error may constitute an epoch. The learning rate may be differently applied according to a repetition number of the epoch. For example, a high learning rate may be used at the beginning of the training of the neural network to allow the neural network to quickly ensure a certain level of performance to increase efficiency and a low learning rate may be used at the end of the training to increase accuracy.

The training data in the training of the neural network may be generally a subset of real data (i.e., data to be processed using (or based on) the trained neural network). Thus, there may be an epoch in which an error for the training data decreases, but an error for real data increases. Overfitting is a phenomenon in which an error for real data increases by excessively learning training data. For example, a phenomenon in which the neural network which sees a yellow cat to learn the cat sees a cat except for the yellow cat not to recognize the cat may be a kind of overfitting. The overfitting may act on the cause of increasing an error in machine learning algorithm. Various optimization methods may be used to prevent such overfitting. A method for increasing training data and using regularization, dropout for deactivating some of nodes of a network in the process of learning, or a batch normalization layer may be applied to prevent the overfitting.

In an implement, the prediction model may correspond to an artificial intelligence-based model which is pre-trained to output a probability distribution of a predicted air conditioning signal predicted for an input air conditioning signal, using (or based on) a dataset.

In an implement, the dataset may refer to a set of data for performing training and verification of the artificial intelligence-based model. The dataset may include a training dataset and/or a verification dataset. The training dataset may be a set of data including pieces of training air conditioning signal data and pieces of training sensor data corresponding to the pieces of training air conditioning signal data. For example, the training dataset may be a set of data used for training in the training process of the prediction model. The verification dataset may be a set of data used to evaluate the prediction model.

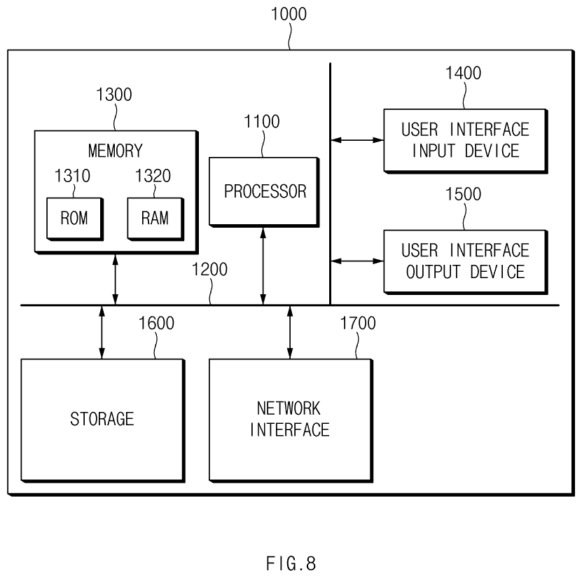

FIG. 8 illustrates a computing system according to an implement of the present disclosure. The computing system may correspond to some of the components of an air conditioning usage scenario prediction apparatus according to an implement of the present disclosure.

Referring to FIG. 8, a computing system 1000 may include at least one processor 1100, a memory 1300, a user interface input device 1400, a user interface output device 1500, a storage 1600, and a network interface 1700, that are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the implements disclosed herein may be embodied directly in hardware or a software module executed by the processor 1100, or in a combination thereof. The software module may reside on a storage medium (e.g., the memory 1300 and/or the storage module 1600) such as a RAM, a flash memory, a ROM, an EPROM, an EEPROM, a register, a hard disc, a removable disk, or a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Implements of the present disclosure may extract meaningful data associated with a specific air conditioning signal to be predicted from a large amount of irregular customer data.

Implements of the present disclosure may derive an accurate deep learning-based prediction technology in which air conditioning usage scenarios of various customers are reflected (or determined) using (or based on) the extracted data, thus improving an actual user usage rate of the air conditioning automation system of the vehicle.

Implements of the present disclosure may expect continuous performance improvement as more pieces of data are accumulated, as an artificial intelligence-based technology is advantageous to improve its performance as there are more pieces of data.

In addition, various effects ascertained directly or indirectly through the present disclosure may be provided.

Hereinabove, although the present disclosure has been described with reference to example implements and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

Accordingly, implements of the present disclosure are intended not to limit but to explain the technical idea of the present disclosure, and the scope and spirit of the present disclosure is not limited by the above implements. The scope of the present disclosure should be construed on the basis of the accompanying claims, and all the technical ideas within the scope equivalent to the claims should be included in the scope of the present disclosure.

What is claimed is:

1. An apparatus for predicting an air conditioning usage scenario, the apparatus comprising:
a processor;
a memory; and
a communication device,
wherein the processor is configured to:
obtain a plurality of pieces of first air conditioning signal data from a plurality of electronic control units (ECUs) provided in a vehicle to perform control of respective functions in the vehicle,
input the plurality of pieces of first air conditioning signal data to an artificial intelligence-based prediction model to obtain a usage scenario for each option, among a plurality of options, of air conditioning, and
transmit the usage scenario to the vehicle.

2. The apparatus of claim 1, wherein the processor is configured to:
obtain a plurality of pieces of training air conditioning signal data and a plurality of pieces of training sensor data for training from the plurality of ECUs in advance, prior to obtaining the plurality of pieces of first air conditioning signal data; and
pre-train the artificial intelligence-based prediction model based on the plurality of pieces of training air conditioning signal data and the plurality of pieces of training sensor data.

3. The apparatus of claim 2, wherein the processor is configured to:
standardize and normalize a variate included in the plurality of pieces of training air conditioning signal data and the plurality of pieces of training sensor data.

4. The apparatus of claim 2, wherein the processor is configured to:
analyze a correlation between the plurality of pieces of training air conditioning signal data and the plurality of pieces of training sensor data to classify the plurality of pieces of training sensor data corresponding to each of the plurality of pieces of training air conditioning signal data.

5. The apparatus of claim 4, wherein the processor is configured to:
select a predetermined number of pieces of 1-1st training sensor data among a plurality of pieces of first training sensor data corresponding to first training air conditioning signal data, based on the correlation; and
generate the training air conditioning signal data and the pieces of 1-1st training sensor data as a training dataset for a first air conditioning option.

6. The apparatus of claim 5, wherein the processor is configured to:
pre-train the artificial intelligence-based prediction model for the first air conditioning option, based on the training dataset for the first air conditioning option.

7. The apparatus of claim 1, wherein the artificial intelligence-based prediction model is configured to:
output a probability distribution to belong to each category for input air conditioning signal data.

8. The apparatus of claim 1, wherein the artificial intelligence-based prediction model is trained based on a cross entropy loss function to output a probability distribution to belong to each category for input air conditioning signal data.

9. The apparatus of claim 1, wherein the vehicle is configured to:
adjust a setting for each option of air conditioning of the vehicle based on the usage scenario.

10. The apparatus of claim 1, wherein the processor is configured to:
obtain a plurality of pieces of second air conditioning signal data and a plurality of pieces of sensor data from the plurality of ECUs, after transmitting the usage scenario to the vehicle; and
additionally train the artificial intelligence-based prediction model based on the plurality of pieces of second air conditioning signal data and the plurality of pieces of sensor data.

11. A method for predicting an air conditioning usage scenario, the method comprising:
obtaining a plurality of pieces of first air conditioning signal data from a plurality of electronic control units (ECUs) provided in a vehicle to perform control of respective functions in the vehicle;
inputting the plurality of pieces of first air conditioning signal data to an artificial intelligence-based prediction model to obtain a usage scenario for each option, among a plurality of options, of air conditioning; and
transmitting the usage scenario to the vehicle.

12. The method of claim 11, further comprising:
obtaining a plurality of pieces of training air conditioning signal data and a plurality of pieces of training sensor data for training from the plurality of ECUs in advance, prior to obtaining the plurality of pieces of first air conditioning signal data; and
pre-training the artificial intelligence-based prediction model based on the plurality of pieces of training air conditioning signal data and the plurality of pieces of training sensor data.

13. The method of claim 11, further comprising:
standardizing and normalizing a variate included in the plurality of pieces of training air conditioning signal data and the plurality of pieces of training sensor data.

14. The method of claim 11, further comprising:
analyzing a correlation between the plurality of pieces of training air conditioning signal data and the plurality of pieces of training sensor data to classify the plurality of pieces of training sensor data corresponding to each of the plurality of pieces of training air conditioning signal data.

15. The method of claim 14, further comprising:
selecting a predetermined number of pieces of 1-1st training sensor data among a plurality of pieces of first training sensor data corresponding to first training air conditioning signal data, based on the correlation; and
generating the training air conditioning signal data and the pieces of 1-1st training sensor data as a training dataset for a first air conditioning option.

16. The method of claim 15, wherein pre-training the artificial intelligence-based prediction model includes:
pre-training the prediction model for the first air conditioning option, based on the training dataset for the first air conditioning option.

17. The method of claim 11, wherein the artificial intelligence-based prediction model is configured to:
output a probability distribution to belong to each category for input air conditioning signal data.

18. The method of claim 11, wherein the artificial intelligence-based prediction model is trained based on a cross entropy loss function to output a probability distribution to belong to each category for input air conditioning signal data.

19. The method of claim 11, further comprising:
adjusting, by the vehicle, a setting for each option of air conditioning of the vehicle based on the usage scenario.

20. The method of claim 11, further comprising:
obtaining a plurality of pieces of second air conditioning signal data and a plurality of pieces of sensor data from the plurality of ECUs, after transmitting the usage scenario to the vehicle; and
additionally training the artificial intelligence-based prediction model based on the plurality of pieces of second air conditioning signal data and the plurality of pieces of sensor data.
